(19) United States
(12) Patent Application Publication
(10) Pub. No.: US 2014/0224283 A1
(43) Pub. Date: Aug. 14, 2014

(54) PROTECTING AND PURGING HEARING AID DEVICES

(71) Applicant: CLEARAID, INC., Ponte Vedra Beach, FL (US)

(72) Inventor: Mansfield Smith, Ponte Vedra Beach, FL (US)

(73) Assignee: Clearaid, Inc., Ponte Vedra Beach, FL (US)

(21) Appl. No.: 13/763,157

(22) Filed: Feb. 8, 2013

(51) Int. Cl. B08B 3/02; B08B 5/02

(52) U.S. Cl. CPC B08B 3/02; B08B 5/02
USPC 134/37; 381/328; 381/330; 134/34

(57) ABSTRACT

Disclosed are various embodiments for purging various hearing aid devices. An enclosure may be used to encapsulate and/or affix a hearing aid device to the enclosure. Content from a purging source may be flushed throughout the enclosure to rid the enclosure and/or the hearing aid device of any debris. Similarly, modifications of hearing aid devices may facilitate the purging of various hearing aid devices by flushing content through the hearing aid device via one or more portals.

### BACKGROUND

Hearing aid devices traditionally have one or more components that must come into contact with the ear canal. The ear canal contains wax, dirt, and debris that not only restricts sound coming from the speaker, but also damages components inside the hearing aid device.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-I are drawings of an enclosure device that may encapsulate and/or be affixed to a receiver-in-canal (RIC) hearing aid device according to various embodiments of the present disclosure.

FIG. 2 is a drawing of a traditional behind-the-ear (BTE) hearing aid device according to various embodiments of the present disclosure.

FIGS. 3A-D are drawings of a modified behind-the-ear (BTE) hearing aid device according to various embodiments of the present disclosure.

FIGS. 4A-B are drawings of a traditional in-the-ear (ITE) hearing aid device according to various embodiments of the present disclosure.

FIGS. 5A-D are drawings of one embodiment of a modified in-the-ear (ITE) hearing aid device according to various embodiments of the present disclosure.

FIGS. 6A-B are drawings of an alternative embodiment of a modified in-the-ear (ITE) hearing aid device according to various embodiments of the present disclosure.

FIGS. 7A-B are drawings of a modified extended wear hearing aid device according to various embodiments of the present disclosure.

FIGS. 8A-B are drawings of a modified speaker device according to various embodiments of the present disclosure.

FIG. 9 is a flowchart illustrating one example of purging a hearing aid device of debris according to various embodiments of the present disclosure.

### DETAILED DESCRIPTION

Hearing aid devices traditionally have one or more components that must come into contact with the ear canal. As may be appreciated, the ear canal contains wax, dirt, skin, and/or debris that not only restricts sound coming from the speaker, but also damages components inside the hearing aid device. The damage from the wax, dirt, and/or debris is a primary reason that most hearing aids last a mere 3-4 years, although capable of a much longer lifespan. Moreover, the removal of debris from a hearing aid device remains problematic, especially for elderly or disabled persons with reduced dexterity and cognitive skills. In the following discussion, a general description of various systems and their components are provided, followed by a discussion of the operation of the same.

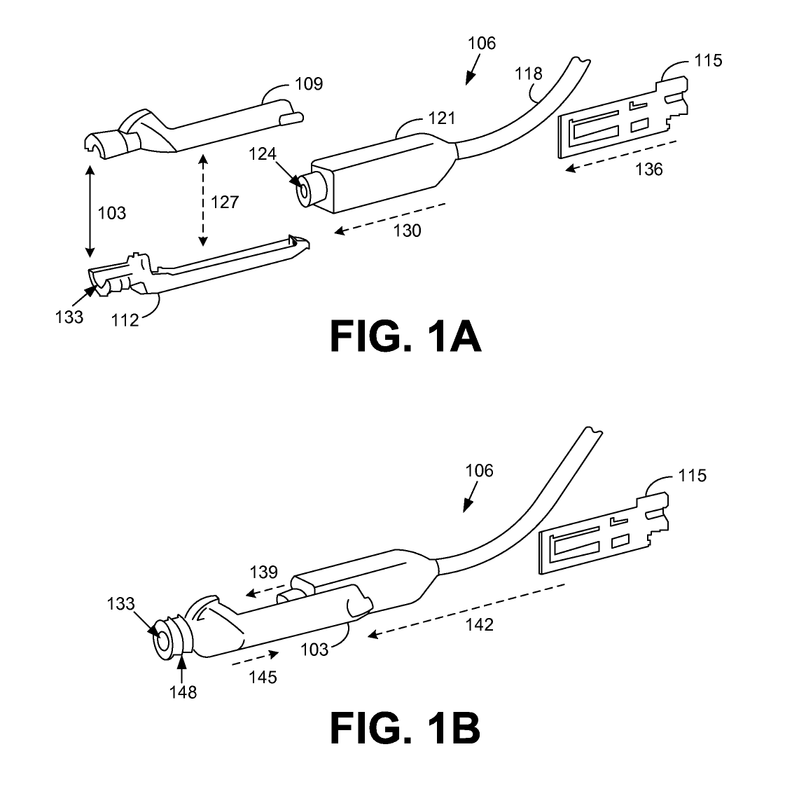

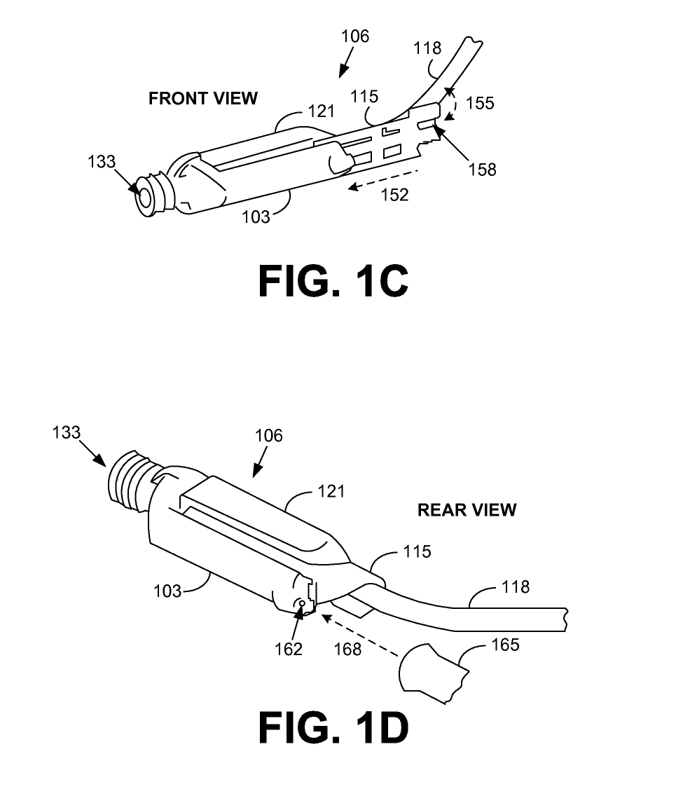

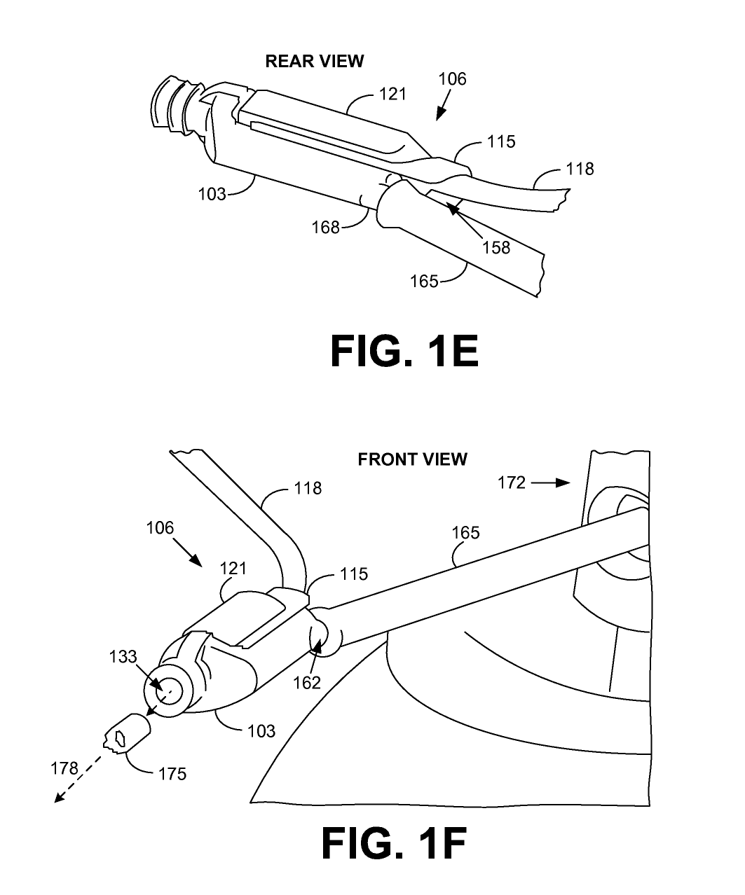

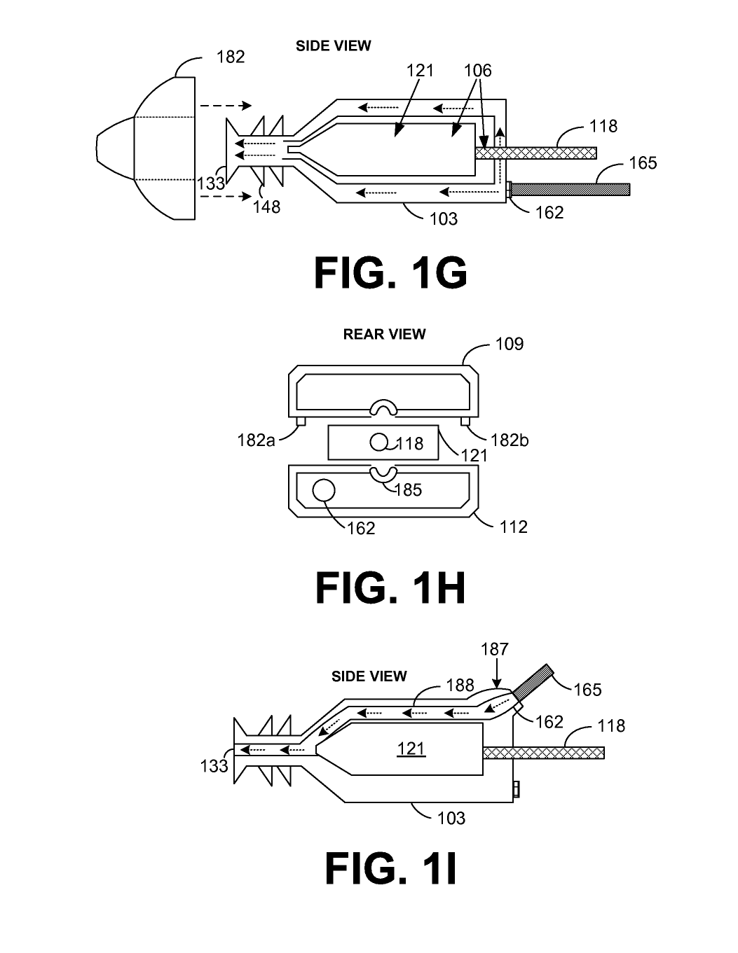

With reference to FIG. 1A, shown is an example of an enclosure 103 that may encapsulate or affix to a receiver-in-canal (RIC) hearing aid device 106. The enclosure 103 may contain, for example, an upper enclosure portion 109 and a lower enclosure portion 112. The upper enclosure portion 109 and the lower enclosure portion 112 may be combined to form the enclosure 103 that encapsulates at least a portion of the RIC hearing aid device 106 and/or affixes to the RIC hearing aid device 106. A slide 115 may also be included to provide additional stability, as will be discussed below.

The RIC hearing aid device 106 may comprise a wire 118, a head unit 121, and a portal 124. As may be appreciated, the portal 124 emits sound captured from a microphone (not shown) and reproduced via a speaker (not shown). The speaker is likely a component of the head unit 121. The upper enclosure portion 109 and the lower enclosure portion 112 may be combined via motion 127 to form a complete enclosure 103. The RIC hearing aid device 106 may be detachably attached to the enclosure 103 by sliding into the enclosure 103 as depicted via motion 130. For example, the enclosure 103 may be designed in such a way that the portal 124 of the RIC hearing aid device 106 snaps into the portal 133 of the enclosure 103. Similarly, the enclosure 103 may be designed in a way that a RIC hearing aid device 106 fits tightly in the enclosure 103 to minimize movement of an attached RIC hearing aid device 106. The slide 115, although optional, may slide between the combination of the RIC hearing aid device 106 and the enclosure 103 via motion 136, as will be discussed in greater detail below. The enclosure 103 may be worn in the ear of a person and/or may be used to clean the RIC hearing aid device 106.

Referring next to FIG. 1B, shown is an enclosure 103 that comprises the previously separated upper enclosure portion 109 (FIG. 1A) and lower enclosure portion 112 (FIG. 1A). In the non-limiting example of FIG. 1B, the upper enclosure portion 109 is combined with the lower enclosure portion 112 to form an enclosure 103. As discussed above with respect to FIG. 1A, the RIC hearing aid device 106 may be detachably attached to the enclosure 103 by sliding into the enclosure 103 as depicted via motion 139. For example, the enclosure 103 may be configured in such a way that the portal 124 (FIG. 1A) of the RIC hearing aid device 106 snaps into the portal 133 of the enclosure 103. Similarly, the enclosure 103 may be configured in such a way that a RIC hearing aid device 106 fits tightly in the enclosure 103 to minimize movement of an attached RIC hearing aid device 106. Also discussed above with respect to FIG. 1A, the slide 115 may slide into the combination of the RIC hearing aid device 106 and the enclosure 103 via motion 142 and/or motion 145, as will be discussed in greater detail below. The portal 133 of the enclosure 103 may further comprise one or more ridges 148 (or threads) that facilitates the addition of a rubber ear piece (not shown) to the portal 133, in order to provide comfort to the wearer of the enclosure 103.

Turning now to FIG. 1C, shown is a non-limiting example of a front view of a slide 115 sliding into a detachably attached position via motion 152. As depicted in FIG. 1C, the RIC hearing aid device 106 is shown in a position encapsulated and attached to the enclosure 103. The slide 115 may be slid into place between the RIC hearing aid device 106 and the enclosure 103. The portal 133 of the enclosure 103 may align with the portal 124 (FIG. 1A) of the RIC hearing aid device 106. The wire 118 of the RIC hearing aid device 106 may be positioned via motion 155 to align the wire 118 with a groove 158 in the slide 115. As may be appreciated, the area where the wire 118 connects to the head 121 of the RIC hearing aid device 106 deteriorates over time due to substantial movement of the wire 118. Thus, the groove 158 in the slide 115 may be used to stabilize movement of the wire 118, especially the portion of the wire 118 where the wire 118 meets the head 121 of the RIC hearing aid device 106.

Moving on to FIG. 1D, shown is a non-limiting example of a rear view of a RIC hearing aid device 106 enclosed and/or detachably attached to an enclosure 103. As discussed above with respect to FIG. 1C, a slide 115 may be used to align a wire 118 of the RIC hearing aid device 106 in a groove 158 (FIG. 1C). The RIC hearing aid device 106 is depicted in a position partially encapsulated and attached to the enclosure 103. A rear portal 162 on the back of the enclosure 103 is shown. A tube 165 of a purging source (not shown) may be aligned and/or detachably attached to the rear portal 162 via motion 168. A purging source may comprise, for example, a canister or bottle of compressed air, proprietary solution, lubricant, or a combination of air, solution, and lubricant. The solution may comprise, for example, sterilizers, cleaners, solutions, lubricants, etc., as may be appreciated. Alternatively, a purging source may be a monofilament, or like component, that may be inserted into the hearing aid device via a portal to either clean or force out any debris. By engaging the purging source, the contents of the purging source (e.g., air, solution, lubricant, etc.) may be channeled through the tube 165, the rear portal 162, and throughout the enclosure 103. By channeling the contents of the purging source throughout the enclosure 103, any free elements (e.g., dirt, skin, wax, etc.) may be forced through the front portal 133 of the enclosure 103.

The rear portal 162 may be designed and/or configured to detachably attach the tube 165 to the enclosure 103. For example, the rear portal 162 may be designed so that a tube 165 of a standard or custom size may snap, attach, or tightly fit when come into contact with the rear portal 162. Although the rear portal 162 is depicted on the back of the enclosure 103, it is understood that one or more similar portals may be placed elsewhere on the enclosure 103 in addition to and/or in place of the rear portal 162. For example, a portal, or a combination of portals, may be placed throughout various parts of the enclosure 103 to facilitate purging free elements from the enclosure 103.

With reference to FIG. 1E, shown is a non-limiting example of a rear view of a RIC hearing aid device 106 attached to an enclosure 103. As discussed above with respect to FIGS. 1C and 1D, a slide 115 may be used to align a wire 118 of the RIC hearing aid device 106 in a groove 158. The RIC hearing aid device 106 is depicted in a position attached to the enclosure 103. As depicted, a tube 165 of a purging source (not shown) may be connected to the rear portal 162 (FIG. 1D). A portion 168 of the enclosure 103 wherein the rear portal 162 resides may be larger than the enclosure 103 in order to facilitate the alignment and/or attachment of the tube 165 to the rear portal 162. Moreover, the portion 168 of the enclosure 103 wherein the rear portal 162 resides may protrude, for example, from the body of the enclosure 103.

By engaging a purging source connected to the tube 165, the contents of the purging source (e.g., compressed air, solution, lubricant, etc.) may be channeled through the tube 165, the rear portal 162, and throughout the enclosure 103. By channeling the contents of the purging source throughout the enclosure 103, any free elements (e.g., dirt, skin, wax, etc.) may be forced through the portal 133 of the enclosure 103.

Referring next to FIG. 1F, shown is a non-limiting example of a front view of a RIC hearing aid device 106 attached to an enclosure 103. As discussed above with respect to FIGS. 1C, 1D, and 1E, a slide 115 may be used to align a wire 118 of the RIC hearing aid device 106 in a groove 158 (FIG. 1C). The RIC hearing aid device 106 is depicted in a position attached to the enclosure 103. As shown, a tube 165 of a purging source 172 may be aligned and/or connected to the rear portal 162. By engaging the purging source 172 connected to the tube 165, the contents of the purging source (e.g., compressed air, solution, lubricant, etc.) may be channeled through the tube 165, the rear portal 162, and throughout the enclosure 103. By channeling the contents of the purging source 172 throughout the enclosure 103, any free elements 175 (e.g., dirt, skin, wax, etc.) may be forced through the front portal 133 of the enclosure 103 in an outward motion 178.

Turning now to FIG. 1G, shown is a non-limiting example of the components of the enclosure 103 and their respective positions. A receiver, speaker, and/or microphone (not shown) may be enclosed in the head 121 of the RIC hearing aid device 106, as may be appreciated. The wire 118 may be aligned in a slide 115 (FIG. 1A) to provide support for the area of the wire 118 that connects to the head 121 of the RIC hearing aid device 106. A tube 165 of a purging source 172 (FIG. 1F) may be aligned and/or connected to the rear portal 162. By engaging the purging source 172 connected to the tube 165, the contents of the purging source (e.g., compressed air, solution, lubricant, etc.) may be channeled through the tube 165, the rear portal 162, and throughout the enclosure 103. By channeling the contents of the purging source 172 throughout the enclosure 103, any free elements (e.g., dirt, skin, wax, etc.) may be forced through the front portal 133 of the enclosure 103. As depicted, when the contents of the purging source 172 enter the enclosure 103 via rear portal 162, the contents may move in one or more directions (e.g., leftward or upward). Accordingly, all free elements may be discharged from the enclosure 103, regardless of their location. The portal 133 of the enclosure 103 may comprise one or more ridges 148 that facilitate the addition of an ear piece 182 (e.g., a rubber or foam ear piece) to the front portal 133, in order to provide comfort to the wearer of the enclosure 103.

Moving on to FIG. 1H, shown is a non-limiting example of the components of the enclosure 103 (FIG. 1C) and their respective positions. As discussed above with respect to FIG. 1A, the enclosure 103 may comprise an upper enclosure portion 109 and a lower enclosure portion 112. The upper enclosure portion 109 and the lower enclosure portion 112 may be combined to form an enclosure 103 via connectors 182a and 182b (e.g., “snap-on” or similar type of connectors) which may be rigidly connected when the upper enclosure portion 109 and the lower enclosure portion 112 are aligned and combined. The wire 118 may be placed in the enclosure 103 and may run through a wire portal 185. A tube 165 (FIG. 1D) of a purging source 172 (FIG. 1F) may be aligned and/or connected to the rear portal 162. As discussed above, contents of the purging source 172 (e.g., compressed air, solution, lubricant, etc.) may be channeled through a tube 165, the rear portal 162, and throughout the enclosure 103. By channeling the contents of the purging source 172 throughout the enclosure 103, any free elements (e.g., dirt, skin, wax, etc.) may be forced through the portal 133 of the enclosure 103.

Moving on to FIG. 1I, shown is a non-limiting example of the components of the enclosure 103 and their respective positions. The head 121 of a RIC hearing aid device 106 may enclose a receiver, (not shown) speaker (not shown), and/or microphone (not shown), as may be appreciated. A wire 118 connected the components of the head 121 (or the RIC hearing aid device 106 itself) may be aligned in a slide 115 (FIG. 1A) to provide support for the area of the wire 118 that connects to the head 121 of the RIC hearing aid device 106. A tube 165 or head of a purging source 172 (FIG. 1F) may be aligned and/or connected to the rear portal 162. The rear portal 162 may reside on a curved or otherwise extending portion 187 of the enclosure 103 that may facilitate the alignment of a tube 165 (or other item) with the rear portal 162.

By engaging the purging source 172 connected to the tube 165, the contents of the purging source (e.g., compressed air, solution, lubricant, etc.) may be channeled through the tube 165, the rear portal 162, and throughout the enclosure 103 via a channel 188. By channeling the contents of the purging source 172 through channel 188, any free elements (e.g., dirt, skin, wax, etc.) may be forced through the front portal 133 of the enclosure 103. As depicted, when the contents of the purging source 172 enter the enclosure 103 via rear portal 162, the contents may move in one or more directions (e.g., leftward or downward). Accordingly, all free elements may be discharged from the enclosure 103, regardless of their location. It is understood that the embodiment of FIG. 1I may be used in combination with the embodiment of FIG. 1G (i.e., two portals) thereby permitting the purge of the enclosure 103 from alternative portals 162.

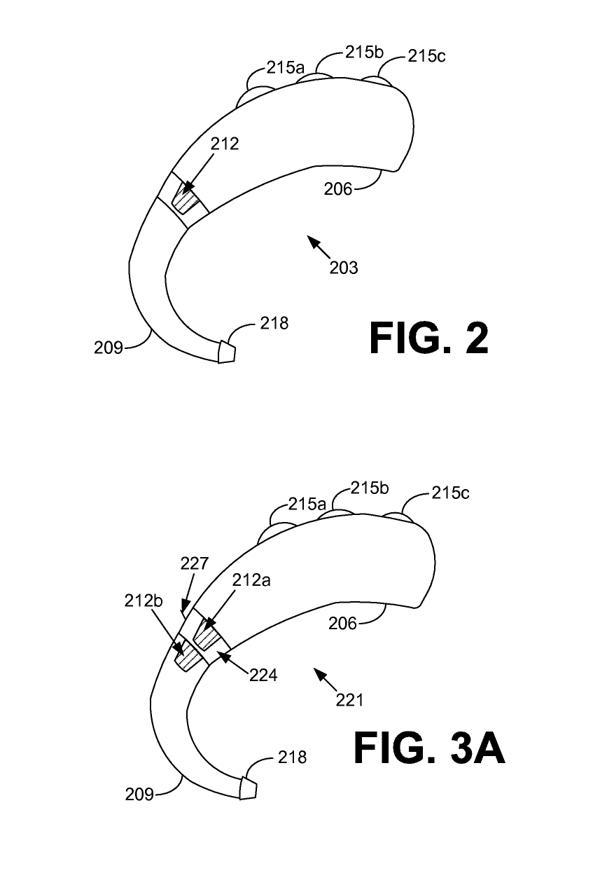

Referring next to FIG. 2, shown is a traditional behind-the-ear (BTE) hearing aid device 203. A BTE hearing aid device 203 may comprise, for example, an upper portion 206 and a lower portion 209 detachably attached or connected via a screw 212 or other appropriate connection component. The upper portion 206 may comprise, for example, a compartment that includes a battery, receiver, speaker, microphone, various circuitry, and/or other components. Similarly components may be configured to protrude from the upper portion 206 (e.g., components 215a, 215b, and/or 215c). For example, these components may include a power button, volume, control, mode selection, a battery compartment, and/or other components. The lower portion 209 may comprise an ear hook used to secure the BTE hearing aid device 203 to the human body by resting the BTE hearing aid device 203 on top of and/or behind the ear. The portal 218 of the BTE hearing aid device 203 may be placed in the ear canal, as may be appreciated.

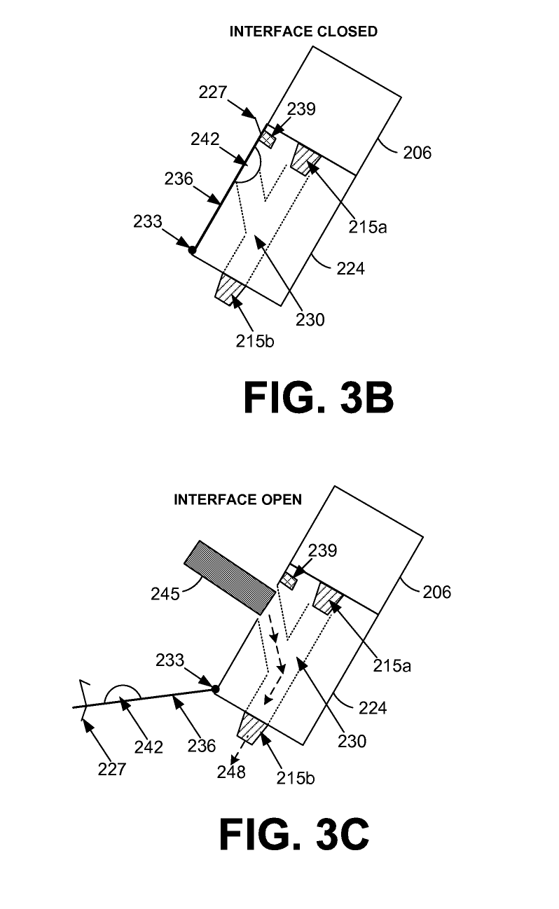

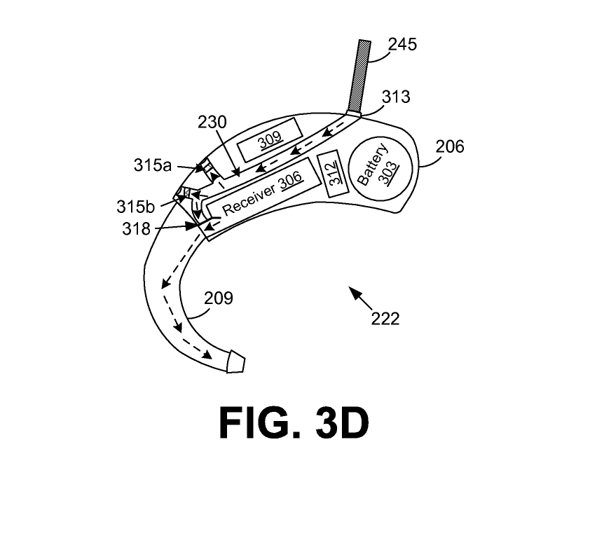

With reference to FIG. 3A, shown is a modified BTE hearing aid device 221. A modified BTE hearing aid device 221 may comprise, for example, an upper portion 206, an intermediary portion 224, and a lower portion 209 connected via a screw 212 or other appropriate connection component. The upper portion 206 may continue to comprise, for example, a compartment that includes a battery, a receiver or speaker, various circuitry, and/or other components. Also, the lower portion 209 may continue to comprise an ear hook used to secure the modified BTE hearing aid device 221 to the human body by resting the modified BTE hearing aid device 221 on top of and/or behind the ear.

The intermediary portion 224 of the modified BTE hearing device 221 may comprise one or more screws (screws 212a and/or 212b) or other appropriate connection components to detachably attach the intermediary portion 224 to a traditional BTE hearing device 221 (not shown). The intermediary portion 224 may further comprise a finger hold 227, or other appropriate component, configured to open to access the interior of the intermediary portion 224, as will be discussed in greater detail below. The portal 218 of the modified BTE hearing aid device 221 may be placed in the ear canal, as may be appreciated.

Referring next to FIG. 3B, shown is an enhanced view of the intermediary portion 224 of a modified BTE hearing device 221 (FIG. 3A). As discussed above with respect to FIG. 3A, the intermediary portion 224 may be detachably attached to the upper portion 206 of the modified BTE hearing device 221 using a screw 212a, or other appropriate connection component. Similarly, the intermediary portion 224 may be detachably attached to the lower portion 209 (FIG. 3A) of the modified BTE hearing device 221 using a screw 212b, or other appropriate connection component. The intermediary portion 224 is depicted in a closed, ready for use, position as will become further evident. For example, a person may engage a finger hold 227 to gain access to the channel 230. A pin 233, comprising of metal, plastic, and/or any other material, may be used to pivot an interface 236 about the pin 233. The interface 236 may be secured back to a closed position (depicted in FIG. 3B) utilizing a connection 239 (e.g., a “snap” connection), as may be appreciated. A sealant 242 (e.g., a rubber sealant) may be configured to plug the channel while the interface 236 is in the closed, ready to use, position.

Turning now to FIG. 3C, shown is another enhanced view of the intermediary portion 224 of a modified BTE hearing device 221 (FIG. 3A). In this non-limiting example, the intermediary portion 224 is depicted with the interface 236 in an open position (not ready for use). For example, a person may engage the finger hold 227 to release the finger hold 227 (or a lever corresponding to the finger hold 227) from a latch in order to access the channel 230 of the intermediary portion 224. As depicted, releasing the finger hold 227 releases the interface 236 from its closed position. The pin 233 may be used to pivot the interface 236 about the pin 233, although the interface 236 may be removed in various embodiments. The sealant 242 which is configured to plug the channel 230 when closed, may be detachably attached to the interface 236. Thus, the sealant 242 is removed from the channel 230 when the interface 236 is opened by pivoting the interface 236 about the pin 233.

Contents of a purging source (e.g., compressed air, solution, lubricant, etc.) may be channeled through a tube 245 detachably attached to the purging source, the channel 230, and throughout the intermediary portion 224. By channeling the contents of the purging source throughout the channel 230, any free elements (e.g., dirt, skin, wax, etc.) may be forced through the screw 212b of the intermediary portion 224, and throughout the lower portion 209 (FIG. 3A) in outward motion 248, as may be appreciated. Accordingly, the screw 212b, or other appropriate connection component, may be hollow and/or comprise a channel facilitating the flush of content through both the intermediary portion 224 and/or the lower portion 209 (FIG. 3A).

Moving on to FIG. 3D, shown is an alternative embodiment of a BTE hearing aid device 222. In the non-limiting example of FIG. 3D, a modified BTE hearing aid device 222 may comprise, for example, an upper portion 206 and a lower portion 209 connected via a screw 212 (FIG. 3A) or other appropriate connection component. The upper portion 206 may continue to comprise, for example, a compartment that includes a battery 303, a receiver 306 or speaker (not shown), a processor 309, and various circuitry 312, and/or other components. As discussed above with respect to FIG. 3A, the lower portion 209 may comprise an ear hook that secures the modified BTE hearing aid device 221 to the human body by resting the modified BTE hearing aid device 221 on top of and/or behind the ear.

Contents of a purging source (e.g., compressed air, solution, lubricant, etc.) may be channeled through a tube 245 detachably attached to the purging source via a portal 313 facilitating the channeling of the contents through a channel 230 existing in the upper portion 206 of the modified BTE hearing aid device 222. By channeling the contents of the purging source throughout the channel 230, any free elements (e.g., dirt, skin, wax, etc.) may be forced through the channel 230 of the upper portion 206, and throughout the lower portion 209 in outward motion, as may be appreciated. The channel 230 may be connected to ports associated with the microphones (e.g., microphone 315a and microphone 315b). Accordingly, the ports associated with the microphones may be purged simultaneously by permitting the contents of the channel 230 to exit via the microphone ports. As may be appreciated, the ports may be closed with a plug while the hearing aid device is in use. Similarly, a valve 318, latch, or other like component, may be used to keep the channel 230 closed during normal operation of the BTE hearing aid device 206. The valve 318 may comprise, for example, a normally-closed spring-loaded check valve. Upon receipt of force against the valve 318 created during a purging of the BTE hearing aid device 206, the valve 318 may open, thereby permitting the purging to flush content through a receiver canal and through the lower portion 209.

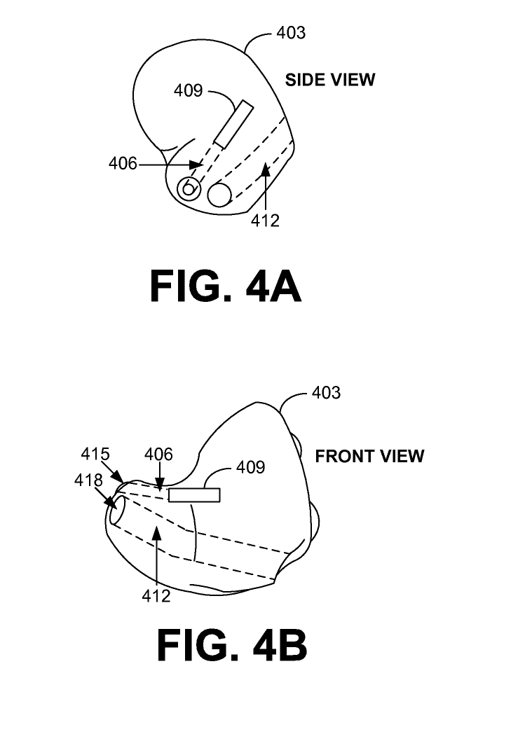

Referring next to FIG. 4A, shown is a side view of a traditional in-the-ear (ITE) hearing aid device 403. An ITE hearing aid device 403 traditionally rests on the outer part of the ear and is generally distinguishable from an in-the-canal (ITC) hearing aid device and/or a completely-in-the-canal (CIC) hearing aid device. An ITE hearing aid device 403 may comprise, for example, a receiver channel 406 to facilitate unimpeded access of audio from the receiver (speaker) 409 to the eardrum. An ITE hearing aid device 403 may further comprise a pressure channel 412 to facilitate ventilation and pressure equalization in the ear.

Turning now to FIG. 4B, shown is a front view of a traditional ITE hearing aid device 403. As discussed above with respect to FIG. 4A, an ITE hearing aid device 403 may comprise, for example, a receiver channel 406 to facilitate unimpeded access of audio from the receiver (speaker) 409 to the eardrum and a pressure channel 412 that facilitates ventilation of pressure equalization in the ear canal. Depicted in the front view of FIG. 4B, a speaker channel portal 415 and a pressure channel portal 418 are shown.

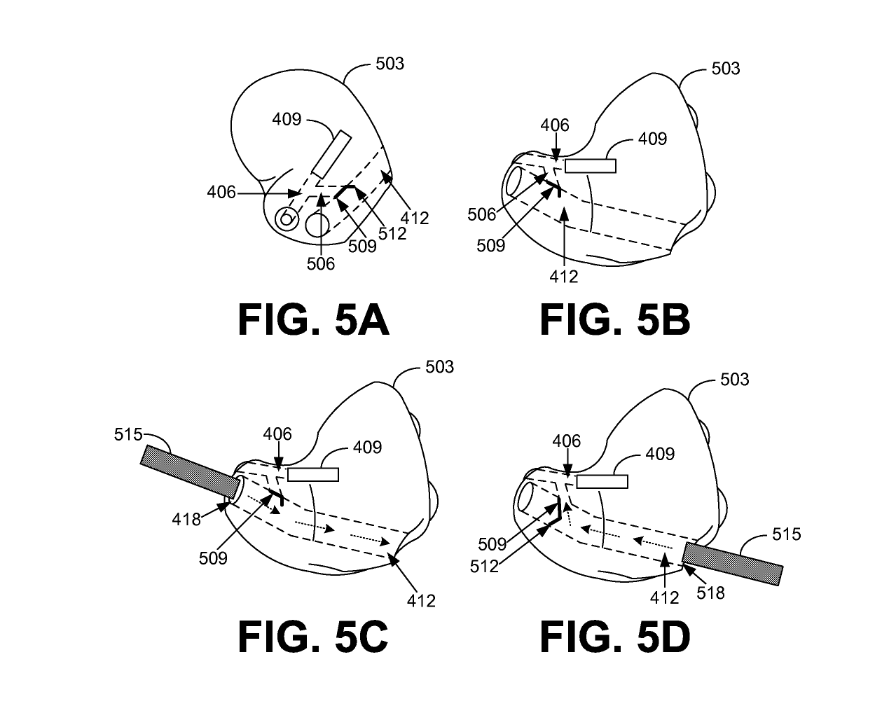

Moving on to FIG. 5A, shown is a side view of a modified ITE hearing aid device 503. The modified ITE hearing aid device 503 may comprise, for example, a receiver channel 406 to facilitate unimpeded access of audio from the receiver (speaker) 409 to the eardrum and a pressure channel 412 to facilitate ventilation and pressure equalization in the ear. An additional channel 506 may interconnect the receiver channel 406 to the pressure channel 412. An optional valve 509 or latch may be used to keep the additional channel 506 closed during normal operation of the ITE hearing aid device 503. The valve 509 may comprise, for example, a normally-closed spring-loaded check valve or a latch. The valve 509 may further comprise, for example, a lip 512 on the distal end. Operation of the valve 509 will be discussed in greater detail below.

Turning now to FIG. 5B, shown is a modified ITE hearing aid device 503. As shown in FIG. 5B, the modified ITE hearing aid device 503 comprises, for example, a receiver channel 406, a receiver (speaker) 409, a pressure channel 412, and an additional channel 506 to interconnect the receiver channel 406 to the pressure channel 412. The valve 509 is configured to keep the additional channel 506 closed during normal operation of the modified ITE hearing aid device 503. Operation of the valve 509 will be discussed in greater detail below.

Referring next to FIG. 5C, shown is a front view of the modified ITE hearing aid device 503. As depicted in FIG. 5C, a tube 515 is aligned with a pressure channel portal 418. The tube 515, for example, may be connected to a purging source (not shown) of content to permit the content to be channeled into the modified ITE hearing aid device 503 in order to force out free items (e.g., wax, skin, dirt, etc.). In the non-limiting example of FIG. 5C, the tube 515 is aligned with a top-most pressure channel portal 418 to flush the ITE hearing aid device 503 with the content. The valve 509 stays in a locked position during the flushing of the ITE hearing aid device 503 to maintain the flow of the content (e.g., fluids and/or gases) down the pressure channel 412.

With respect to FIG. 5D, shown is the modified ITE hearing aid device 503. As depicted in FIG. 5D, a tube 515 is aligned with the a bottom-most pressure channel portal 518 to flush the ITE hearing aid device 503 with content from a purging source (not shown). During a flush of the ITE hearing aid device from the bottom-most pressure channel portal 518, a valve 509, or latch, opens from its locked position (e.g., via a spring) upon the lip 512 coming into contact with the content being flushed through the channel 412. By opening the valve 509 or the latch, the content is directed from the tube 515 to the receiver channel 406. As may be envisioned, one may complete a purging of a modified ITE hearing aid device 503 by conducting a two-step process: i.e., purging from the top-most pressure channel portal 418 (FIG. 5C) and from the bottom-most pressure channel portal 518.

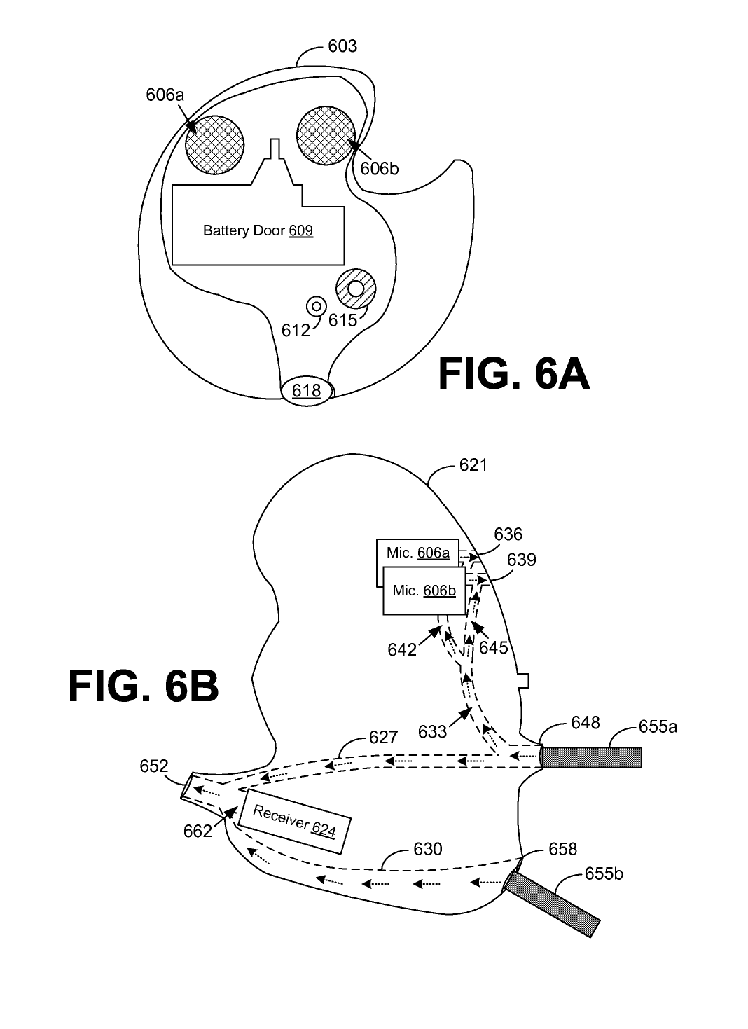

Moving on to FIG. 6A, shown is an alternative embodiment of a modified ITE hearing aid device 603. An ITE hearing aid device 603 may comprise, for example, battery 606a, battery 606b, battery door 609, program switch 612, port 615, and/or vent 618. The program switch 612 may be modified to be a port, similar to port 615, to be used as an entry and/or exit point for contents in order to purge the ITE hearing aid device 603 of debris. The program switch 612 may be closed using a plug, vent, door, or similar component while in use.

Likewise, the port 615 and/or vent 618 may be used as entry and/or exit points for contents to enter and/or exit in order to purge the ITE hearing aid device 603. A tube (not shown) or other content source may be aligned with program switch 612, port 615, and/or vent 618. The tube 515, for example, may be connected to a purging source (not shown) of content to permit the content to be channeled into the modified ITE hearing aid device 603 in order to force out free items (e.g., wax, skin, dirt, etc.).

Turning now to FIG. 6B, shown is an alternative embodiment of a modified ITE hearing aid device 603. As discussed above with respect to FIG. 6A, an ITE hearing aid device 621 may comprise, for example, battery 606a and/or battery 606b. In the non-limiting example of FIG. 6B, shown is a receiver 624 which may be connected to one or more channels (i.e., channel 627 and/or channel 630). As shown in FIG. 6B, channel 627 may branch into channel 633 to permit the clearing of microphone port 636 and/or microphone port 639. To do so, channel 633 may branch into channel 642 and channel 645. Accordingly, contents entering port 648 may flow throughout channel 627, channel 633, channel 642, and/or channel 645 and out of microphone port 636, microphone port 639, and/or port 652. As discussed above a straw 655a, or other like component (e.g., a microfilament), may be used to channel source of content throughout the hearing aid device via port 648. Likewise, a port 658 may exist to facilitate the purging of channel 630 utilizing a straw 655b or other like component. As shown in FIG. 6B, channel 630 and channel 627 may meet with a channel 662 connected to the receiver 624 to purge the channel 662 connected to the receiver 624. Although discussed as exit ports above, it is understood that port 652, port 636, and/or port 639 may be used as entry ports (i.e., content is entered through these ports) and/or port 648 or port 658 may be used as exit ports (i.e., content exits through these ports).

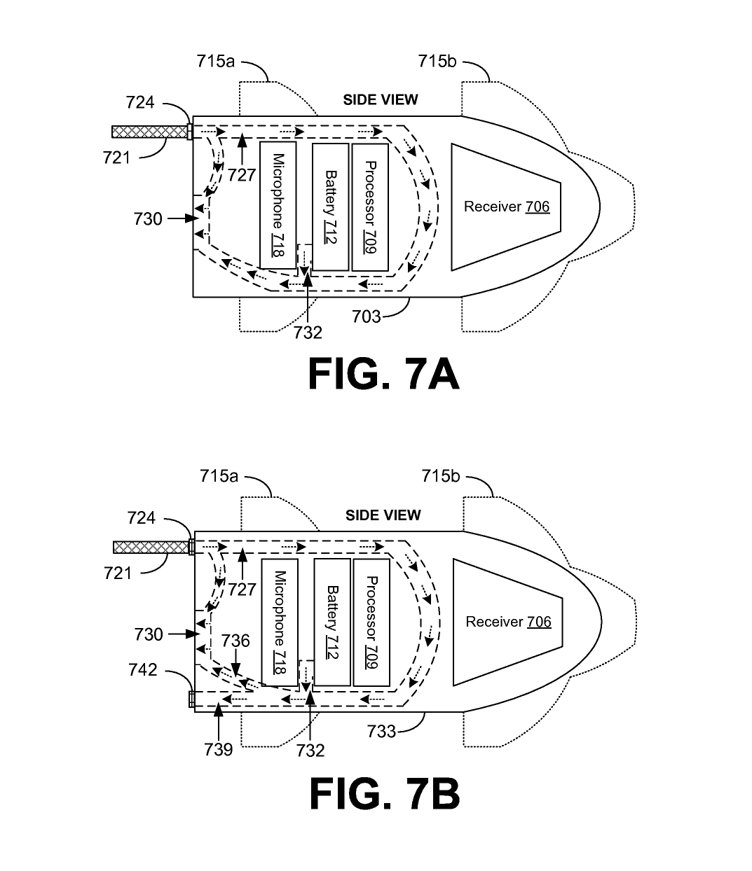

With respect to FIG. 7A, shown is a non-limiting example a modified extended wear hearing aid device, such as a Lyric® hearing aid device commercially available from Phonak LLC in Warrenville, Ill., 703 according to one or more embodiments. Typically, extended wear hearing aid devices are placed in the ear canal requiring surgery or like-invasive procedure to remove or replace the device. Extended wear hearing aid devices may flex about the middle of the device or may be rigid throughout. In the non-limiting example of FIG. 7A, a modified extended wear hearing aid device 703 is shown comprising a receiver 706, a processor 709, a battery 712, a seal 715a, a seal 715b, and/or a microphone 718. Although shown in respective locations in the extended wear hearing aid device 703, it is understood that the components may be positioned elsewhere in the device.

A tube 721 or other like component attached to a content source (not shown) may be detachable attached to portal 724. The contents of the content source may be channeled throughout the extended wear hearing aid device 703 utilizing channel 727. Accordingly, the contents of the content source, as well as any free materials cleansed from the device, may be forced through vent 730. Additionally, a channel 732 may connect channel 727 with the battery 712. The channel 732 may facilitate the purging of a chamber in which the battery 712 resides in addition to the channel 732 itself.

Moving on to FIG. 7B, shown is an alternative embodiment of a modified extended wear hearing aid device 733 according to one or more embodiments. Similar to the non-limiting example of FIG. 7A, a modified extended wear hearing aid device 733 is shown comprising a receiver 706, a processor 709, a battery 712, a seal 715a, a seal 715b, and/or a microphone 718. Although shown in respective locations in the extended wear hearing aid device 703, it is understood that the components may be positioned elsewhere in the device.

Also similar to FIG. 7A, a tube 721 or other like component attached to a content source (not shown) may be detachable attached to portal 724. The contents of the content source may be channeled throughout the extended wear hearing aid device 703 utilizing channel 727. However, channel 727 may branch into channel 736 and channel 739. Channel 736, for example, channels the contents of the content source through vent 730. On the other hand, channel 739 channels the contents of the content source through portal 742. Accordingly, the contents of the content source, as well as any free materials cleansed from the device, may be forced through both vent 730 and portal 742. Likewise, portal 742 may be used as an entry points, reversing the flow of the contents throughout the extended wear hearing aid device 733. In this non-limiting example, the contents will be channeled throughout channel 727 and through portal 724, portal 724 used as the exit point of the contents from the device. Additionally, a channel 732 may connect channel 727 with the battery 712. The channel 732 may facilitate the purging of a chamber in which the battery 712 resides in addition to the channel 732 itself.

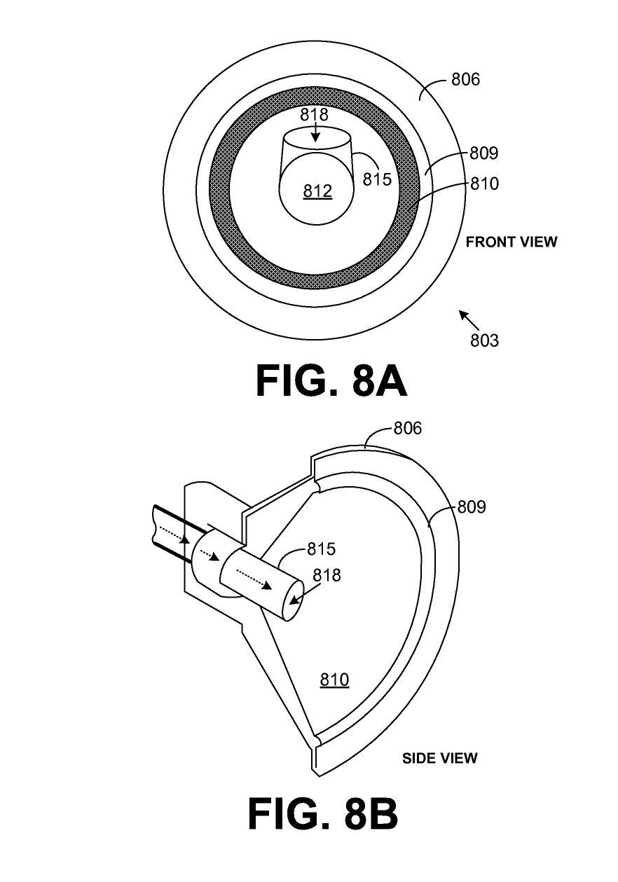

Turning now to FIG. 8A, shown is a front view of a modified speaker 803 that may reside in one or more hearing aid devices. As may be appreciated, a speaker 803 in a hearing aid device may come into contact with and/or may be inhibited by debris existing in the ear canal. Accordingly, a speaker 803 may be modified to include a channel to purge debris from a hearing aid device. For example, a traditional speaker may comprise a frame 806 (also known as a basket), a surround 809, a diaphragm 810, and a dust cap 812. A traditional speaker may be modified to include a modified pole piece 815 that extends from behind the dust cap 812 to beyond the front of the speaker 803. The modified pole piece 815 may be hollow to create a channel to facilitate the purging of debris from behind the speaker 803, through the pole piece 815, and out the front of the speaker 803 through a portal 818.

With respect to FIG. 8B, shown is a side view (dissected) of the modified speaker 803 of FIG. 8A that may reside in one or more hearing aid devices. In this non-limiting example, a modified speaker 803 may comprise a frame 806, a surround 809, a diaphragm 810, and a dust cap (not shown). As shown in FIG. 8B, a modified pole piece 815 extends from behind the dust cap (not shown) to beyond the front of the speaker 803. The modified pole piece 815 is depicted in FIG. 8B as hollow thereby creating a channel to facilitate the purging of debris from behind the speaker, through the pole piece 815, and out the front of the speaker through a portal 818.

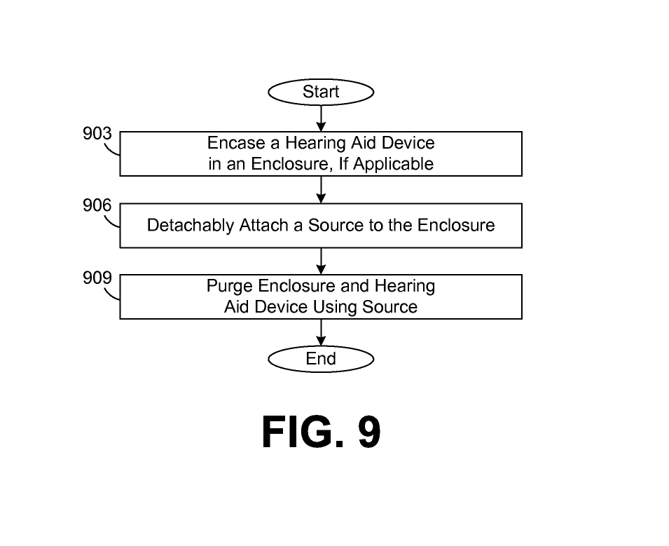

Referring next to FIG. 9, shown is a flowchart that provides one example of the operation of flushing a hearing aid device of debris according to various embodiments. It is understood that the flowchart of FIG. 9 provides merely an example of the many different types of functional arrangements that may be employed to implement the flushing a hearing aid device of debris as described herein. As an alternative, the flowchart of FIG. 9 may be viewed as depicting an example of steps of a method implemented to flush a hearing aid device of debris according to one or more embodiments.

Beginning with box 903, a hearing aid device may be whole or partially encapsulated and/or detachably attached to an enclosure. For example, in FIG. 1A, a hearing aid device, or portions thereof, may be inserted into or attached to an enclosure 103. Referring back to FIG. 9, in various embodiments, the hearing aid device may be modified to include channels, portals, and/or vents such that the use of an additional enclosure is not warranted.

Next, in box 906, a purging source may be detachably attached to the enclosure 103 or to the hearing aid device itself, if applicable. For example, a purging source (e.g., bag, canister, or bottle) of content (e.g., cleaning solution, compressed air, lubricant) may be aligned with and/or connected to a portal of the enclosure utilizing a tube and/or nozzle. Alternatively, a physical item (e.g., a monofilament, string, etc.) may be inserted into the enclosure 103, or the hearing aid device itself to clean and/or force debris through one or more channels.

In box 909, the enclosure and the hearing aid device may be purged using the purging source. For example, content from a purging source may be channeled through the tube and through the portal into the enclosure. As a non-limiting example, a user may engage a canister of compressed air to force air throughout the enclosure. Alternatively, a user may engage a bottle of solution to force the solution throughout the enclosure, throughout a straw-like component connected to the enclosure, and/or the channels of the enclosure. Channels may be created in an existing enclosure and/or hearing aid device by forcing gas or a component through the enclosure and/or hearing aid device during a manufacturing process. The content forced throughout the enclosure and/or channels of the enclosure, as well as any free items picked up during the purge, may exit the enclosure or the hearing aid device through one or more portals. Moreover, the solution may lubricate and/or condition the enclosure, as may be appreciated.

Although the flowchart of FIG. 9 shows a specific order of execution, it is understood that the order of execution may differ from that which is depicted. For example, the order of execution of two or more blocks may be scrambled relative to the order shown. Also, two or more blocks shown in succession in FIG. 9 may be executed concurrently or with partial concurrence. Further, in some embodiments, one or more of the blocks shown in FIG. 9 may be skipped or omitted.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method comprising:
attaching a hearing aid device to an enclosure, the enclosure encapsulating at least a portion of the hearing aid device; and
applying content from a purging source to a first portal of the enclosure, the content clearing at least a portion of the hearing aid device and the enclosure of debris, the enclosure configured to facilitate the emission of the content and the debris from a second portal.

2. The method of claim 1, further comprising the step of aligning a tube connected to the purging source to the first portal of the enclosure.

3. The method of claim 1, wherein the content comprises compressed air.

4. The method of claim 1, wherein the content comprises a solution.

5. The method of claim 1, wherein the purging source comprises a canister of compressed air or a bottle of solution.

6. An in-the-ear (ITE) hearing aid device, comprising:
a first channel configured to facilitate a transmission of audio from a receiver;
a second channel configured to facilitate a pressurization of an ear canal in which the ITE hearing aid device resides; and
a third channel coupled to the first channel and the second channel, the third channel configured to facilitate a flow of content throughout the first channel and the second channel, the content originating from a purging source.

7. The ITE hearing aid device of claim 6, further comprising a latch coupled to the third channel, the latch configured to close access to the first channel and the third channel.

8. The ITE hearing aid device of claim 7, the latch further comprising a lip coupled to the latch, the lip configured to open the latch upon a flush of content of the ITE hearing aid device.

9. The ITE hearing aid device of claim 6, wherein the content comprises compressed air.

10. The ITE hearing aid device of claim 6, wherein the content comprises a solution.

11. The ITE hearing aid device of claim 6, wherein the purging source comprises a canister of compressed air or a bottle of solution.

12. A behind-the-ear (BTE) hearing aid device, comprising:
an upper portion of the BTE hearing aid device coupled an intermediary portion of the BTE hearing aid device;
the intermediary portion of the BTE hearing aid device coupled to a lower portion of the BTE hearing aid device; and
the intermediary portion comprising:
a release configured to free an interface from a closed state to an open state, the open state comprising access to a channel internal to the intermediary portion;
the channel configured to facilitate a flush of the intermediary potion of the BTE hearing aid device with content from a purging source.

13. The BTE hearing aid device of claim 12, further comprising a sealant coupled to the interface, the sealant configured to plug the channel during the closed state.

14. The BTE hearing aid device of claim 12, further comprising a pin coupled to the interface and the intermediary portion, the pin configured to rotate the interface about the pin.

15. The BTE hearing aid device of claim 12, wherein the release is a finger hold.

16. The BTE hearing aid device of claim 12, wherein the release is coupled to the intermediary portion using a releasable connector.

17. The BTE hearing aid device of claim 12, wherein the intermediary portion is coupled to the lower portion using a hollow connection component configured to facilitate the flush of content through the intermediary portion and the lower portion.

18. The BTE hearing aid device of claim 12, wherein the content comprises compressed air.

19. The BTE hearing aid device of claim 12, wherein the content comprises a solution.

20. The BTE hearing aid device of claim 12, wherein the purging source comprises a canister of compressed air or a bottle of solution.
